(19) United States
(12) Patent Application Publication
(10) Pub. No.: US 2023/0415414 A1
(43) Pub. Date: Dec. 28, 2023

(54) 3D PRINTING USING A MICRO LED ARRAY

(71) Applicant: Lumileds LLC, San Jose, CA (US)

(72) Inventors: Marcus Hendrikus Adrianus van Steen, Eindhoven (NL); Rob Jacques Paul Engelen, Eindhoven (NL); Nicola Bettina Pfeffer, Eindhoven (NL)

(21) Appl. No.: 17/986,733

(22) Filed: Nov. 14, 2022

Related U.S. Application Data
(60) Provisional application No. 63/354,840, filed on Jun. 23, 2022.

(51) Int. Cl. B29C 64/277; B29C 64/255; B29C 64/227; B33Y 10/00; B33Y 30/00; B29C 64/124

(52) U.S. Cl. CPC B29C 64/277; B29C 64/255; B29C 64/227; B33Y 10/00; B33Y 30/00; B29C 64/124

(57) ABSTRACT

A three-dimensional (3D) printer includes a build platform, a resin tank configured to hold resin, a micro-light emitting diode (LED) array including micro-LEDs situated to provide ultraviolet (UV) or blue light to the resin in the resin tank, and a control circuit configured to control which LEDs of the micro-LED array are active and pattern the light produced by the micro-LED array for selectively curing the resin in the resin tank.

### CLAIM OF PRIORITY

This application claims the benefit of U.S. Provisional Application No. 63/354,840, filed on Jun. 23, 2022, which is hereby incorporated by reference in its entirety printing.

### TECHNICAL FIELD

The present disclosure relates generally to using light emitting diodes (LEDs) in three-dimensional (3D) printing.

### BACKGROUND

Use of micro-LED displays or projectors is an emerging technology in the lighting and display industry. A micro-LED array can contain arrays of thousands to millions of microscopic LED pixels that actively emit light. Micro-LEDs (sometimes called “μLEDs” or “uLEDs”) of the array can be individually controlled. As compared to other display technologies, micro-LED arrays can have a higher brightness and better energy efficiency, making them attractive for a variety of applications, such as television display or backlight, automotive lighting, manufacturing or mobile phone lighting.

### SUMMARY

In embodiments, a micro-LED array provides various benefits and advantages in 3D printing. The micro-LED array can reduce an amount of time required to generate a 3D printed product. The micro-LED array can be used to cure resin in 3D printing. The micro-LED array can form a patterned image that defines what resin is cured by incident light. The micro-LED array includes LEDs that do not light intensity power as their size decreases. This is in contrast to LCD technology that loses transmission power with reduced size. The product generated using the micro-LED array can have a smoother outer surface than products generated using other technologies. This is because the micro-LEDs can have a better resolution than the LCD technology or laser technology. One or more motors can be deployed to attain the improved resolution or the micro-LEDs can have a pitch that is sufficient to produce better resolution than the LCD of laser technology.

### BRIEF DESCRIPTION OF THE DRAWINGS

FIG. 1 illustrates, by way of example, a diagram an embodiment of a method for MSLA 3D printing.

FIG. 2 illustrates, by way of example, a diagram of an embodiment of a 3D printer system that includes a light source.

FIG. 3 illustrates, by way of example, a diagram of an embodiment of a 3D printer system that includes a micro-LED display.

FIG. 4 illustrates, by way of example, an exploded view diagram of an embodiment of a portion of the system.

FIG. 5 illustrates, by way of example, a diagram of an embodiment of a method for 3D printing using a micro-LED array.

FIG. 6 illustrates one example of a lighting matrix control system having a suitable lighting logic and control module and/or pulse width modulation module to permit separately controlled and adjusted pixel intensity by setting appropriate ramp times and pulse width.

FIG. 7 illustrates in more detail one chip level implementation of a system supporting functionality such as discussed with respect to FIGS. 1-6.

FIG. 8 illustrates, by way of example, a block diagram of an embodiment of a machine (e.g., a computer system) in which another circuit or method discussed herein can be used.

### DETAILED DESCRIPTION

Stereo Lithography Apparatus (SLA) 3D printers build a product layer by layer. Each layer is formed by solidifying parts of a liquid resin. The resin turns from a liquid into a solid by exposure to blue or ultraviolet (UV) light. For the exposure, a light source and a projection mechanism are used. Examples are (i) a blue laser with moving mirrors and (ii) liquid crystal displays (LCDs) with a UV light emitting diode (LED) backlight. The backlight is an example of a light source. Some modern printers use the latter exposure type, named Masked SLA (MSLA). Some parameters of any of these 3D printers are their productivity (how many products per unit time can be produced), the product surface quality (how smooth or rough is the surface of the product), and the downtime (e.g., a ratio of an amount of time the printer is operating versus not operating).

Although the light output of MSLA systems is, in general, higher than the light output of laser-based printers, it is still not ideal. Also, a limited spatial resolution of LCDs and their deterioration caused by the UV backlight limit applications of the MSLA.

By replacing the LCD and LED backlight with an LED display (e.g., a micro-LED display) a shorter exposure time per layer of the product, smaller pixel pitch for smoother product surfaces, and lower maintenance costs can be achieved. The micro-LED display can include LEDs of a configurable wavelength or a wavelength that cures the resin of the product.

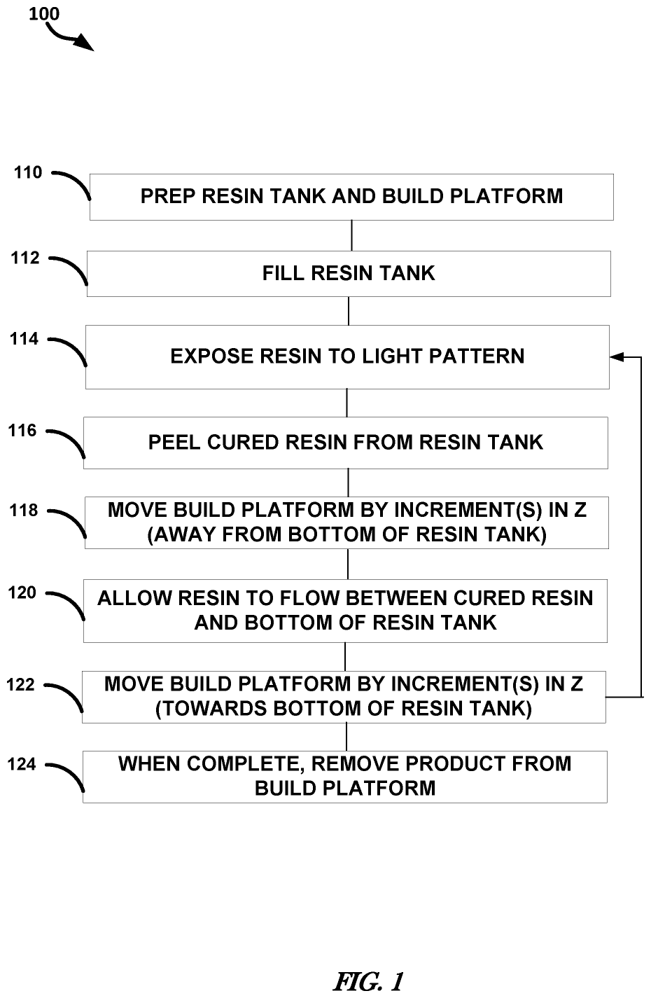

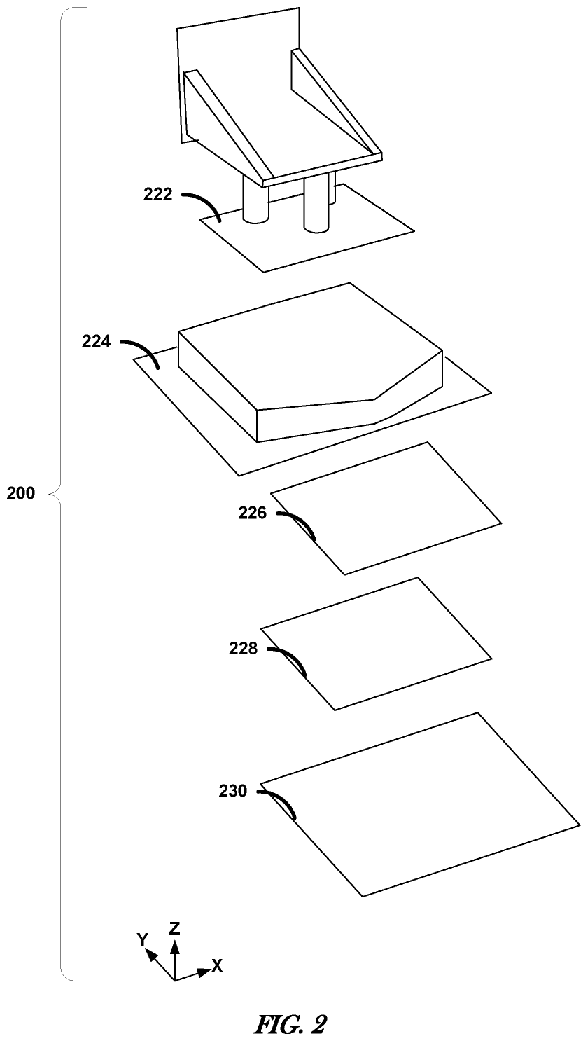

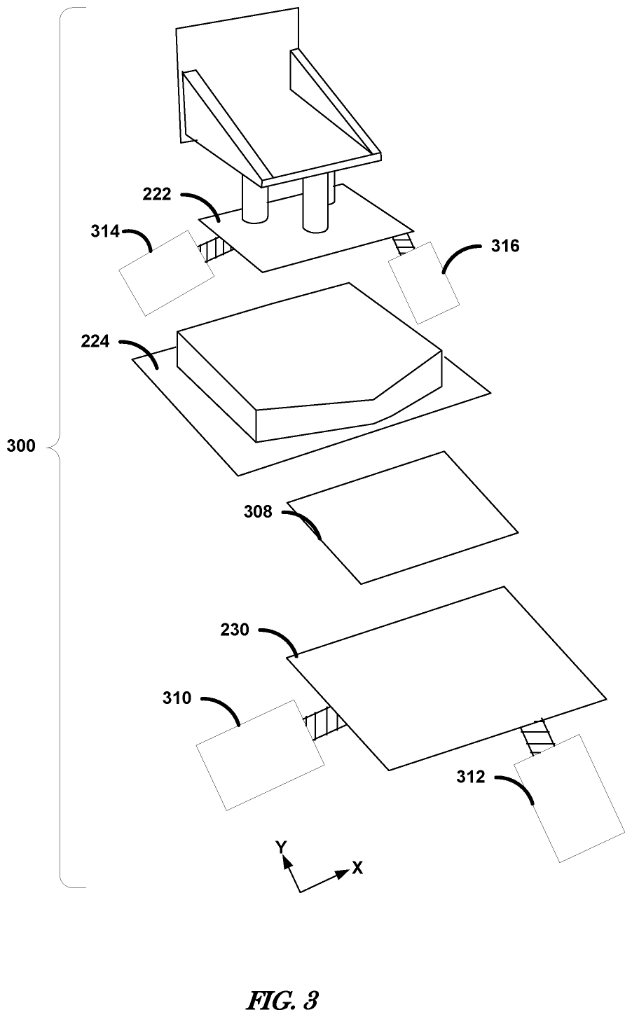

FIG. 1 illustrates, by way of example, a diagram an embodiment of a method 100 for MSLA 3D printing. The method 100 as illustrated includes preparing a resin tank and build platform (see FIGS. 2 and 3 for example MSLA and SLA system diagrams, respectively), at operation 110; filling the resin tank, at operation 112; exposing resin along a bottom of the rein tank to a light pattern, at operation 114; peeling a cured resin from the resin tank, at operation 116; moving the build platform by one or more increments away from the bottom of the resin tank in a z-direction, at operation 118; allowing uncured resin to flow between cured resin and bottom of resin tank, at operation 120; moving the build platform by one or more increments towards the bottom of the resin tank in the z-direction, at operation 122; and, when a product is complete, removing a final cured resin product from the build platform, at operation 124.

The operation 110 can include adding a film to or cleaning the resin tank that makes it not bond with the resin whether the resin is in solid or liquid form. Prepping the build platform can include adding a film to, cleaning the build platform, initiating suction to the build platform, or the like, that makes the cured resin bond to the build platform. The operation 114 can include adjusting a pattern formed on a mask or by a microLED array. The operation 116 can include moving the build platform at operation 118 or a mechanical sweep of the bottom of the resin, or the like. The operation 118 can include moving the build platform sufficient distance to allow resin to flow between the cured resin and the bottom of the resin tank at operation 120. The operation 120 can move the build platform back down towards the bottom of the resin tank to make sure only a specified depth of resin is situated between the product and the bottom of the resin tank. The operation 124 can include mechanically separating the cured resin from the build platform, discontinuing suction, or the like.

FIG. 2 illustrates, by way of example, a diagram of an embodiment of a 3D printer system 200 that includes a light source 228. The 3D printer system 200 as illustrated includes a build platform 222, a resin tank 224, a mask 226, the light source 228, and a platform 230 that is optionally mobile. The build platform 222 moves in a z-direction. The resin tank 224 contains the resin that is cured by light exposure against the build platform 222. The build platform 222 can move up and down relative to resin in the resin tank 224 to move the cured resin and expose additional resin to the light from the light source 228.

The resin tank 224 is a container that retains the liquid and cured resin in a confined space. There are a variety of container shapes, materials, and sizes that can be used. The bottom of the tank is transparent to wavelengths of light that cure the resin. It is important that the liquid resin does not attach to the resin tank 224.

The mask 226 can be a digitally configurable mask surrounded by a static mask. A static mask is a sheet that includes UV transparent and UV opaque portions. The UV transparent portions allow the UV light from the light source 228 (e.g., a UV backlight of an LCD or other light source) to pass therethrough and be incident on the resin for curing. The UV opaque portions prevent the UV light from the light source 108 from passing therethrough. A digitally configurable mask can also include UV transparent and opaque portions, but the UV transparent and UV opaque portions are controlled by an electric field incident thereon. The electric field can cause a physical change in a component of the mask 226 that makes the component either transparent or opaque to the light from the light source 228. An example of such a component includes a liquid crystal. Thus, the mask 226 and light source 228 can be parts of an LCD. The mask 106 can include liquid crystals and polarizers to control the opacity of each pixel of the mask 226. A backlight of the LCD is the light source 228 that projects the image produced by the liquid crystals to the resin tank 224.

The display platform 230 provides mechanical support for the light source 228.

FIG. 3 illustrates, by way of example, a diagram of an embodiment of a 3D printer system 300 that includes a micro-LED display 308. The system 300 is similar to the system 200 with the system 300 including the micro-LED display 308 in place of the light source 228 and the system 300 does not include the mask 226 but can optionally include the mask 226 situated between the micro-LED display 308 and the resin tank 224. The mask 226 is not required as the micro-LED display 308 includes LEDs that are controllable on an individual or group level so the micro-LED display 308 has a sort of “built-in” mask by micro-LED control. The system 300 includes the build platform 222, the resin tank 224, the display platform 230, and the micro-LED display 308.

The micro-LED display 308 generates light that is directly incident on the resin in the resin tank 224. “Directly incident” means that the light does not penetrate through any structures, other than collimating components, between the micro LED display 308 and bottom of the resin tank 224. Light that penetrates through any structures that are not collimating optical elements, such as the mask 226 between the micro-LED display 308 and the bottom of the resin tank 224 is considered “indirectly incident” on the resin.

The micro-LED display 308 includes an array or arrays of micro-LEDs. Micro-LEDs can support high density pixels having a lateral dimension less than 100 micrometers (μm) by 100 μm. In some embodiments, micro-LEDs with dimensions of about 50 jam in diameter or width and smaller can be used. In some other embodiments, micro-LEDs with dimensions of about 75 μm in diameter or width and smaller can be used. Such micro-LEDS can be used for the manufacture of UV or blue light displays. In some embodiments, micro-LEDS can be defined on a monolithic gallium nitride (GaN) or other semiconductor substrate, formed on segmented, partially, or fully divided semiconductor substrate, or individually formed or panel assembled as groupings of micro-LEDs. In some embodiments, the LED display 208 can include small numbers of micro-LEDs positioned on substrates that have a centimeter scale area or greater. In some embodiments, the LED display 208 can support micro-LED pixel arrays with hundreds, thousands, or millions of LEDs positioned together on centimeter scale area substrates or smaller. In some embodiments, micro-LEDS can include LEDs sized between 30 microns and 500 microns. In some embodiments, the micro-LED pixel arrays can be formed from LEDs of various types, sizes, and layouts. In some embodiments, one-dimensional (1D) or two-dimensional (2D) matrix arrays of individually addressable LEDs can be used. Commonly, N×M arrays where N and M are respectively between one and one thousand, or other positive integer, can be used. Individual LED structures can have a square, rectangular, hexagonal, polygonal, circular, arcuate, or other surface shape. Arrays of the LED assemblies or structures can be arranged in geometrically straight rows and columns, staggered rows or columns, or semi-random or random layouts. LED assemblies that can include multiple LEDs formed as individually addressable pixel arrays are also supported. In some embodiments, radial or other non-rectangular grid arrangements of conductive lines to the LED can be used. In other embodiments, curving, winding, serpentine, and/or other suitable non-linear arrangements of electrically conductive lines to the LEDs can be used.

Given the absence of the mask 226 on the micro-LED display 308, the output power can be much higher compared to a similar system that includes the light source 228 and the mask 226. The limit to resolution of the system 300 is posed by a pixel pitch of micro-LEDs in the micro-LED display 308. The pixel pitch is the distance between two directly adjacent pixels in the micro-LED display 308. A pixel of the micro-LED display 308 includes an LED and corresponding driver circuitry. In some embodiments, each of the LEDs can include its own dedicated driver circuitry while in other embodiments the LEDs can be grouped into groups of two or more LEDs and each group of LEDs can include its own dedicated driver circuitry.

The display platform 230 can either be static or mobile. The display platform 230 can be moved by one or more motors 310, 312, such as by a stepper motor or other type of motor by a fixed amount.

Similarly, the build platform 222 can either be static or mobile. The build platform 222 can be moved by one or more motors 314, 314, such as by a stepper motor or other type of motor by a fixed amount.

In contrast to the light source 228 based system, micro-LED displays 308 keep about the same light output even when their size is shrunk. Thus, a smaller LED can produce about a same amount of light as a larger LED. This means that higher resolutions are attainable using LEDs since more light can be output by shrinking the size of the LED. Since the display resolution relates 1:1 with a minimum feature size in the product, a higher resolution enables more detailed products and smoother surfaces. Smoother surfaces means that less time or costs are involved in manufacturing and post processing steps of the product.

The LEDs of the micro-LED display 308 can have blue or UV wavelengths, whatever is more optimal for the curing process of the resin. The micro-LED display 308 can be fixed, or mobile relative to the resin tank 224 via movement of the display platform 230 or build platform 222. The display platform 230 or build platform 222 can be moved, by the motor 310, 312, 314, or 316 to several set positions (e.g., multiple set position in X, multiple set positions in Y). By moving, by the display platform 230 or the build platform 222, the micro-LED display 308 can be situated a fraction of the pixel pitch from a previous resin exposure event. Thus, a resolution even finer than the pixel pitch can be achieved. Moving the build platform 222 or the display platform 230 so as to situate the micro-LED display 208 a fraction of the pixel pitch relative to a prior exposure and doing an extra exposure (as controlled by control circuitry 440, an even finer resolution can be gained (at the cost of some productivity loss). The UV LEDs can be mounted on a thin-film-transistor (TFT) active substrate. The TFT does not need to be transparent since a backlight is not needed.

One embodiment can include a linear micro-LED array sized N×M pixels, where N and M are positive integers, aligned with either X or Y axis. The micro-LED array can illuminate the resin row wise by moving motor either 310 or 314 if the display is aligned in Y direction or by moving motor 312 or 316 if the display is aligned in X direction. In both cases the motor would make M steps. The LEDs can be off during a move, and the correct pattern can be imaged after each step. In this fashion, a resolution of N×M pixels can be obtained.

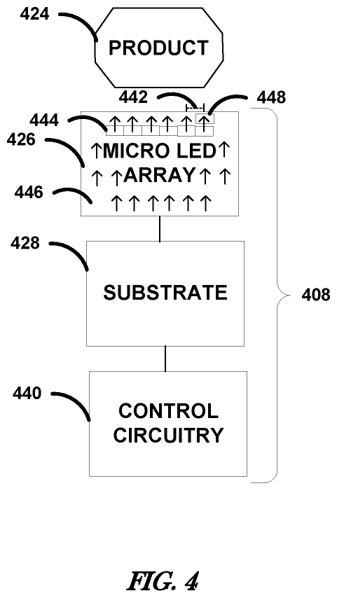

FIG. 4 illustrates, by way of example, an exploded view diagram of an embodiment of a portion of the system 300. The embodiment of FIG. 4 includes a resin product 424 that is resin cured by light from the micro-LED display 308. The resin product 424 is the item that is printed by 3D printer with micro-LED display 308. The resin product 424 is any item that can be printed by the 3D printer system 300. The limitations on what can be built using the 3D printer system 300 include the size of the resin tank 224, the size and resolution of the micro-LED display 308, the distance the build platform 222 can be moved in Z direction, among others. The system 300 can achieve sub-pixel resolution in a same time as a manufacturing time using the system 200. This is due, at least in part, because of smaller round off errors due to raster of LEDs used to construct curved surfaces. Said another way, the quantization error in an x-y plane can be smaller using the system 300.

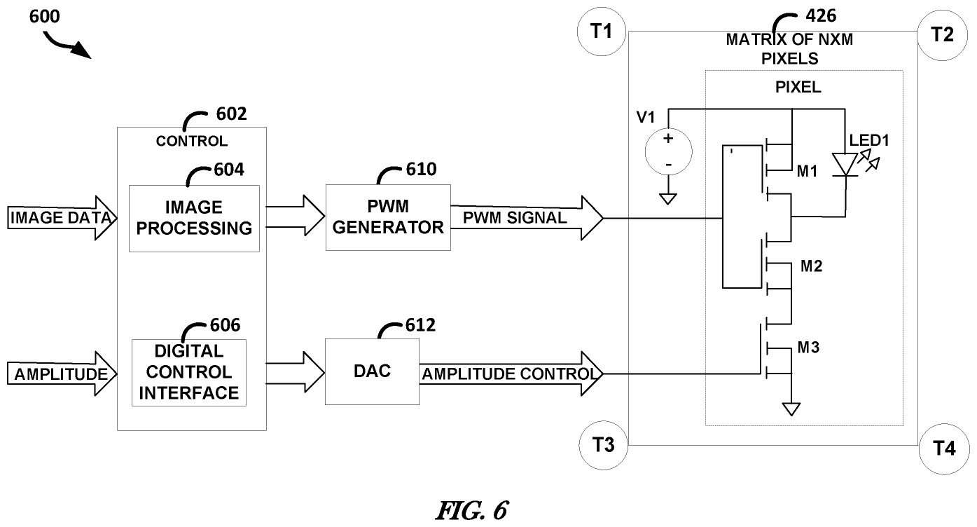

The micro-LED display 308 includes a micro-LED array 426, a substrate 428 electrically coupled to the micro-LED array 426, and control circuitry 440 electrically coupled to the substrate 428. The micro-LED array 426 comprises pixels of micro-LEDs and corresponding electrical components for driving the micro-LEDs based on one or more control signals from the control circuitry 440. More details regarding the micro-LED array 426 and what comprises a pixel are provided in FIG. 6. Light blocking fences 444 (see FIG. 4) may be used around each LED in the micro LED display 308, such as to reduce light crosstalk between pixels. The light blocking fences 444 can include a reflective material or a reflective coating on an otherwise less reflective material. The light blocking fences 444 can be coupled to a surface 446 of the micro-LED array 426 facing the resin tank 224 in which the product 424 is being formed. The light blocking fences 444 can respectively completely surround an LED of the micro-LED array 426. The light blocking fences 444 can extend from the surface 446 towards the product 424 or a resin tank 224 in which the product 424 is being formed.

One or more collimating optical components 448 can be situated to receive light from the micro-LED array 426. The optical components 448 can include one or more lenses, reflectors, mirrors, or the like situated to alter the light from the micro-LED array 426 from Lambertian to a collimated beam.

The substrate 428 can include an array of TFTs or other switches, one switch for each LED or group of LEDs in the micro-LED array 426. The control circuitry 440 can control an electric field incident on the substrate 428 to control which pixels of the micro-LED array 426 are active or inactive. The shape and number of active LED pixels controls a shape and intensity of the light that is produced by the micro-LED display 308. The substrate 428 provides an interface through which the control circuitry 440 can control individual pixels of the micro-LED array 426.

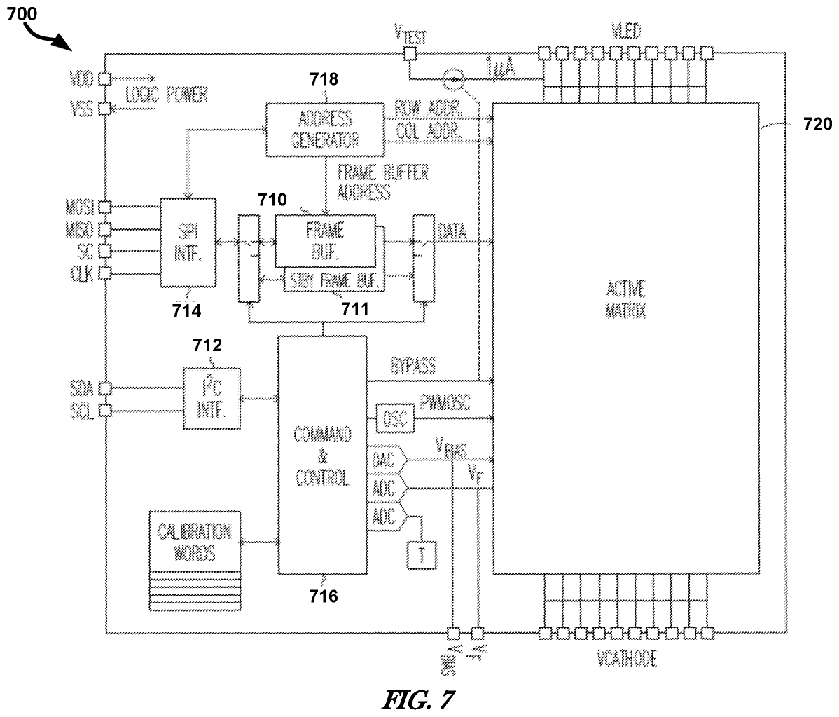

The control circuitry 440 includes electric or electronic components configured to generate signals that control a state of the LEDs of the micro-LED display 308. The electric or electronic components are described elsewhere herein. More details regarding the control circuitry 330 are provided in FIGS. 6 and 7, among others.

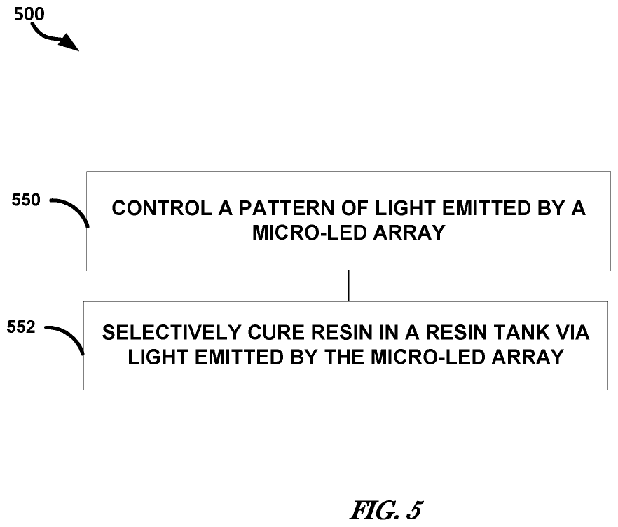

FIG. 5 illustrates, by way of example, a diagram of an embodiment of a method 500 for 3D printing using a micro-LED array. The method 500 as illustrated includes controlling, by a control circuit configured to control ultraviolet (UV) or blue light emitted by light emitting diodes (LEDs) of a micro-LED array, a pattern of light emitted by the micro-LED array, at operation 550; and selectively curing, by the light from the micro-LED array being incident on a resin in a resin tank situated to receive the light, the resin, at operation 552.

The method 500 can further include, wherein resolution of features of a resin product produced by curing of the resin is defined by a pitch between the LEDs of the micro-LED array. The method 500 can further include moving, by one or more motors coupled to a display platform on which the micro-LED array is situated, the display platform.

The method 500 can further include moving, by one or more motors coupled to a build platform to which a product comprising the cured resin adheres, the build platform. The method 500 can further include, wherein moving the display platform or build platform includes moving the display platform or build platform by less than a pitch between directly adjacent LEDs of the micro-LED array, and the method further comprises exposing the resin, via the micro-LED array, before and after the moving of the display platform or build platform. The method 500 can further include, wherein the light from the micro-LED array is provided directly to the resin in the resin tank.

FIG. 6 illustrates one example of a lighting matrix control system 600 having a suitable lighting logic and control module and/or pulse width modulation module to permit separately controlled and adjusted pixel intensity by setting appropriate ramp times and pulse width. Such adjusted pixel intensity, ramp times, or pulse width can help adjust a net intensity and pattern of the light provided by the micro-LED display 308. Addressable LED pixel activation can be used to provide patterned lighting, to reduce color or intensity variations, and to provide various pixel diagnostic functionality.

A micro-LED array such as illustrated in FIG. 6 can contain arrays of thousands to millions of microscopic LED pixels that actively emit light and are individually controlled. To emit light in a pattern or sequence that results in display of an image, the current levels of the micro-LED pixels at different locations on an array can be adjusted individually according to a specific image. This can involve a constant current source or pulse width modulation (PWM) source, which turns on and off the pixels at a certain frequency. During PWM operation, the average direct current (DC) through a pixel is the product of the current amplitude and the PWM duty cycle, which is the ratio between the conduction time and the period or cycle time.

Processing modules that facilitate efficient usage of the system 600 are illustrated in FIG. 6. The system 600 includes a control module 602 able to implement pixel or group pixel level control of amplitude and duty cycle for a micro-LED array 426. In some embodiments the system 600 further includes an image processing module 604 to generate, process, or transmit an image, and digital control interfaces 606 such as inter-integrated circuit (FC) (FC is a synchronous, multi-leader, multi-follower, packet switched, single-ended, serial communication bus) that are configured to transmit control data or instructions. The digital control interfaces 606 and control module 602 may include the system microcontroller and any type of wired or wireless module configured to receive a control input from an external device. By way of example, a wireless module may include blue tooth, Zigbee, Z-wave, mesh, WiFi, near field communication (NFC) and/or peer to peer modules may be used. The microcontroller may be any type of special purpose computer or processor that may be configured or configurable to receive inputs from the wired or wireless module or other modules in the LED system and provide control signals to other modules based thereon. Algorithms implemented by the microcontroller or other suitable control module 602 may be implemented in a computer program, software, or firmware incorporated in a non-transitory computer-readable storage medium for execution by the special purpose processor. Examples of non-transitory computer-readable storage mediums include a read only memory (ROM), a random-access memory (RAM), a register, cache memory, and semiconductor memory devices. The memory may be included as part of the microcontroller or may be implemented elsewhere, either on or off a printed circuit or electronics board.

The term module, block, circuitry, or the like, as used herein, may refer to electrical and/or electronic components disposed on individual circuit boards that may be soldered to one or more electronics boards. The term module may, however, also refer to electrical and/or electronic components that provide similar functionality, but which may be individually soldered to one or more circuit boards in a same region or in different regions. Electrical and/or electronic components can include one or more electric or electronic components mentioned elsewhere.

As previously noted, control module 602 can further include the image processing module 604 and the digital control interfaces 606, such as can be implemented using I²C. In some embodiments an image processing computation may be done by the control module 602 through directly generating a modulated image. Alternatively, a standard image file can be processed or otherwise converted to provide modulation to match the image. Image data that mainly contains PWM duty cycle values can be processed for all pixels in image processing module 604. Since amplitude is typically a fixed value or a value that is not changed very often, amplitude related commands can be given separately through a different digital interface, (e.g., another I²C, a controller area network (CAN), universal asynchronous transmitter/receiver (UART), serial peripheral interface (SPI), universal serial bus (USB), or the like). The control module 602 interprets the digital data, which is then used by a PWM generator 610 of the control module 602 to generate PWM signals for pixels, and by Digital-to-Analog Converter (DAC) signals from the DAC 612 to generate the control signals for generating the required current source amplitude.

In some embodiments, discrete temperature sensors (T1-T4) can be used for temperature monitoring that can supplement or provide calibration for the described pixel level temperature monitoring system and method. In embodiments, the pixel matrix 620 in FIG. 6 can include N×M pixels that can support pixel level or group pixel level control.

The control module 602 can be controlled by a higher-level controller, such as the control circuitry 440 or command and control module 716 (see FIG. 7). The control module 602 can include or implement the functionality of the control circuitry 440 or vice versa.

FIG. 7 illustrates in more detail one chip level implementation of a system 700 supporting functionality such as discussed with respect to FIGS. 1-6. The system 700 includes a command-and-control module 716 able to implement pixel or group pixel level control of amplitude and duty cycle for pixel circuitry. In some embodiments, the system 700 further includes a frame buffer 710 for holding generated or processed images that can be supplied to an active LED matrix 720. Other modules can include digital control interfaces such as I²C serial bus 712 or SPI interface 714 that are configured to transmit needed control data or instructions.

In operation, system 700 can accept image or other data from a 3D printer source that arrives via the SPI interface 714. Successive images or video data can be stored in an image frame buffer 710.

In operation, pixels in the images are used to define response of corresponding LED pixels in the active matrix, with intensity and spatial or temporal modulation of LED pixels being based on the image(s). To reduce data rate issues, groups of pixels (e.g., K×L blocks of pixels where K and L are integers greater than one) can be controlled as single blocks in some embodiments. In embodiments, high speed and high data rate operation is supported, with pixel values from successive images able to be loaded as successive frames in an image sequence at a rate between 30 Hz and 100 Hz, with 60 Hz being typical. PWM can be used to control each pixel to emit light in a pattern and with an intensity at least partially dependent on the image held in the image frame buffer 610.

In some embodiments, the system 700 can receive logic power via Vdd and Vss pins. An active matrix receives power for LED array control by multiple VLED and VCathode pins. The SPI interface 714 can provide full duplex mode communication using a master-slave architecture with a single master. The leader device originates the frame for reading and writing. Multiple follower devices are supported through selection with individual follower select (SS) lines. Input pins can include a Leader Output Follower Input (MOSI), a Leader Input Follower Output (MISO), a chip select (SC), and clock (CLK), all connected to the SPI interface 714. The SPI interface connects to an address generator, frame buffer, and a standby frame buffer. Pixels can have parameters set and signals or power modified (e.g., by power gating before input to the frame buffer, or after output from the frame buffer via pulse width modulation or power gating) by a command-and-control module. The SPI interface 714 can be connected to an address generator module 718 that in turn provides row and address information to the active matrix 720. The address generator module 718 in turn can provide the frame buffer address to the frame buffer 710.

In some embodiments, the command-and-control module 716 can be externally controlled via an I²C serial bus 712. A clock (SCL) pin and data (SDA) pin with addressing can be supported. The command-and-control module 716 can include a digital to analog converter (DAC) and two analog to digital converters (ADC). These are respectively used to set V_{bias} for a connected active matrix, help determine maximum V_{f}, and determine system temperature. Also connected are an oscillator (OSC) to set the pulse width modulation oscillation (PWMOSC) frequency for the active matrix 720. In embodiments, a bypass line is also present to allow address of individual pixels or pixel blocks in the active matrix for diagnostic, calibration, or testing purposes. The active matrix 720 can be further supported by row and column select that is used to address individual pixels, which are supplied with a data line, a bypass line, a PWMOSC line, a Vbias line, and a Vf line.

As will be understood, in some embodiments the described circuitry and active matrix 720 can be packaged and optionally include a submount or printed circuit board connected for powering and controlling light production by the semiconductor LED. In certain embodiments, the printed circuit board can also include electrical vias, heat sinks, ground planes, electrical traces, and flip chip or other mounting systems. The submount or printed circuit board may be formed of any suitable material, such as ceramic, silicon, aluminum, etc. If the submount material is conductive, an insulating layer is formed over the substrate material, and the metal electrode pattern is formed over the insulating layer. The submount can act as a mechanical support, providing an electrical interface between electrodes on the LED and a power supply, and also provide heat sinking.

More generally, light emitting active-matrix pixel arrays such as discussed herein may support applications that benefit from fine-grained intensity, spatial, and temporal control of light distribution. This may include, but is not limited to, precise spatial patterning of emitted light from pixel blocks or individual pixels. Depending on the application, emitted light may be spectrally distinct, adaptive over time, and/or environmentally responsive. The light emitting pixel arrays may provide pre-programmed light distribution in various intensity, spatial, or temporal patterns. The emitted light may be based at least in part on received sensor data and may be used for optical wireless communications. Associated optics may be distinct at a pixel, pixel block, or device level. An example light emitting pixel array may include a device having a commonly controlled central block of high intensity pixels with an associated common optic, whereas edge pixels may have individual optics. The active matrix 720 is another instance of the micro-LED array 426 and can provide UV or blue light for curing resin of a 3D printer.

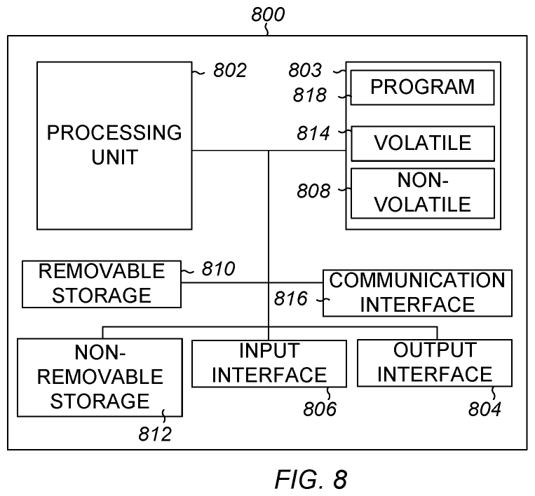

FIG. 8 illustrates, by way of example, a block diagram of an embodiment of a machine 800 (e.g., a computer system) in which the control circuitry 440, control module 602, PWM generator 610, DAC 612, address generator module 718, command and control module 716, method 100, method 500, or other component or operation of FIGS. 1-5, a combination thereof or another circuit or method discussed herein can be used. One example machine 800 (in the form of a computer), may include a processing unit 802, memory 803, removable storage 810, and non-removable storage 812. Although the example computing device is illustrated and described as machine 800, the computing device may be in different forms in different embodiments. Further, although the various data storage elements are illustrated as part of the machine 800, the storage may also or alternatively include cloud-based storage accessible via a network, such as the Internet.

Memory 803 may include volatile memory 814 and non-volatile memory 808. The machine 800 may include—or have access to a computing environment that includes—a variety of computer-readable media, such as volatile memory 814 and non-volatile memory 808, removable storage 810 and non-removable storage 812. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices capable of storing computer-readable instructions for execution to perform functions described herein.

The machine 800 may include or have access to a computing environment that includes input 806, output 804, and a communication connection 816. Output 804 may include a display device, such as a touchscreen, that also may serve as an input device. The input 806 may include one or more of a touchscreen, touchpad, mouse, keyboard, camera, one or more device-specific buttons, one or more sensors integrated within or coupled via wired or wireless data connections to the machine 800, and other input devices. The computer may operate in a networked environment using a communication connection to connect to one or more remote computers, such as database servers, including cloud-based servers and storage. The remote computer may include a personal computer (PC), server, router, network PC, a peer device or other common network node, or the like. The communication connection may include a Local Area Network (LAN), a Wide Area Network (WAN), cellular, Institute of Electrical and Electronics Engineers (IEEE) 802.11 (Wi-Fi), Bluetooth, or other networks.

Computer-readable instructions stored on a computer-readable storage device are executable by the processing unit 802 (sometimes called processing circuitry) of the machine 800. A hard drive, CD-ROM, and RAM are some examples of articles including a non-transitory computer-readable medium such as a storage device. For example, a computer program 818 may be used to cause processing unit 702 to perform one or more methods or algorithms described herein.

Note that the term “circuitry” or “circuit” as used herein refers to, is part of, or includes hardware components, such as transistors, resistors, capacitors, diodes, inductors, amplifiers, oscillators, switches, multiplexers, logic gates (e.g., AND, OR, XOR), power supplies, memories, or the like, such as can be configured in an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” or “circuit” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry”, “processing circuitry”, or “processor” as used herein thus refers to, is part of, or includes circuitry capable of sequentially and automatically carrying out a sequence of arithmetic or logical operations, or recording, storing, and/or transferring digital data. These terms may refer to one or more application processors, one or more baseband processors, a physical central processing unit (CPU), a single- or multi-core processor, and/or any other device capable of executing or otherwise operating computer-executable instructions, such as program code, software modules, and/or functional processes.

### Additional Notes and Examples

Example 1 includes a three-dimensional (3D) printer comprising a build platform, a resin tank configured to hold resin, a micro-light emitting diode (LED) array including micro-LEDs situated to provide ultraviolet (UV) or blue light to the resin in the resin tank, and a control circuit configured to control which LEDs of the micro-LED array are active and pattern the light produced by the micro-LED array for selectively curing the resin in the resin tank.

In Example 2, Example 1 further includes, wherein resolution of features of a resin product produced by curing of the resin is defined by a pitch between LEDs of the micro-LED array.

In Example 3, at least one of Examples 1-2 further includes a display platform on which the micro-LED array is situated, and one or more motors coupled to the display platform, the motors configured to move the display platform relative to the resin.

In Example 4, at least one of Examples 1-3 further includes one or more motors coupled to the build platform, the motors configured to move the cured resin relative to the micro-LED array.

In Example 5, at least one of Examples 3-4 further includes, wherein the control circuit is further configured to control the motors.

In Example 6, Example 5 further includes, wherein the control circuit is further configured to move the display platform or build platform by less than a pitch between directly adjacent LEDs of the micro-LED array and expose the resin, via the micro-LED array, before and after the moving of the display platform or build platform.

In Example 7, at least one of Examples 1-6 further includes, wherein the light from the micro-LED array is provided directly to the resin in the resin tank.

In Example 8, at least one of Examples 1-7 further includes reflective walls extending from a surface of the micro-LED array facing the resin towards the resin tank, the reflective walls configured to reduce cross-talk between the LEDs.

In Example 9, at least one of Examples 1-8 further includes an active substrate, wherein the micro-LED array is electrically and mechanically connected to the active substrate.

In Example 10, at least one of Examples 1-9 further includes optical components situated to collimate light from LEDs of the micro-LED array before it is incident on a bottom surface of the resin tank.

Example 11 includes a method of making or using one of Examples 1-10.

Example 12 includes circuitry configured to control a pattern of ultraviolet (UV) or blue light emitted by light emitting diodes (LEDs) of a micro-LED array, and move, by one or more motors coupled to a display platform on which the micro-LED array is situated or a build platform to which a cured resin adheres, the display platform or the build platform.

In Example 13, Example 12 further includes, wherein moving the display platform or build platform includes moving the display platform or build platform by less than a pitch between directly adjacent LEDs of the micro-LED array, and the method further comprises exposing the resin, via the micro-LED array, before and after the moving of the display platform or build platform.

In Example 14, at least one of Examples 12-13 further includes, wherein the light from the micro-LED array is provided directly to the resin in the resin tank.

Modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims. It is also understood that other embodiments of this invention may be practiced in the absence of an element/step not specifically disclosed herein. In those embodiments supporting software-controlled hardware, the methods, procedures, and implementations described herein may be realized in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs).

1. A three-dimensional (3D) printer comprising:
a build platform;
a resin tank configured to hold resin;
a micro-light emitting diode (LED) array including micro-LEDs situated to provide ultraviolet (UV) or blue light to the resin in the resin tank; and
a control circuit configured to control which LEDs of the micro-LED array are active and pattern the light produced by the micro-LED array for selectively curing the resin in the resin tank.

2. The 3D printer of claim 1, wherein resolution of features of a resin product produced by curing of the resin is defined by a pitch between LEDs of the micro-LED array.

3. The 3D printer of claim 1, further comprising:
a display platform on which the micro-LED array is situated; and
one or more motors coupled to the display platform, the motors configured to move the display platform relative to the resin.

4. The 3D printer of claim 1, further comprising:
one or more motors coupled to the build platform, the motors configured to move the cured resin relative to the micro-LED array.

5. The 3D printer of claim 4, wherein the control circuit is further configured to control the motors.

6. The 3D printer of claim 5, wherein the control circuit is further configured to move the display platform or build platform by less than a pitch between directly adjacent LEDs of the micro-LED array and expose the resin, via the micro-LED array, before and after the moving of the display platform or build platform.

7. The 3D printer of claim 1, wherein the light from the micro-LED array is provided directly to the resin in the resin tank.

8. The 3D printer of claim 1, further comprising:
reflective walls extending from a surface of the micro-LED array facing the resin towards the resin tank, the reflective walls configured to reduce cross-talk between the LEDs.

9. The 3D printer of claim 1, further comprising an active substrate, wherein the micro-LED array is electrically and mechanically connected to the active substrate.

10. The 3D printer of claim 1, further comprising:
optical components situated to collimate light from LEDs of the micro-LED array before it is incident on a bottom surface of the resin tank.

11. A method for three-dimensional (3D) printing, the method comprising:
controlling, by a control circuit configured to control ultraviolet (UV) or blue light emitted by light emitting diodes (LEDs) of a micro-LED array, a pattern of light emitted by the micro-LED array; and
selectively curing, by the light from the micro-LED array being incident on a resin in a resin tank situated to receive the light, the resin.

12. The method of claim 11, wherein resolution of features of a resin product produced by curing of the resin is defined by a pitch between the LEDs of the micro-LED array.

13. The method of claim 11, further comprising:
moving, by one or more motors coupled to a display platform on which the micro-LED array is situated, the display platform.

14. The method of claim 11, further comprising:
moving, by one or more motors coupled to a build platform to which a product comprising the cured resin adheres, the build platform.

15. The method of claim 14, wherein moving the display platform or build platform includes moving the display platform or build platform by less than a pitch between directly adjacent LEDs of the micro-LED array, and the method further comprises exposing the resin, via the micro-LED array, before and after the moving of the display platform or build platform.

16. The method of claim 11, wherein the light from the micro-LED array is provided directly to the resin in the resin tank.

17. A control circuit comprising:
circuitry configured to:
control a pattern of ultraviolet (UV) or blue light emitted by light emitting diodes (LEDs) of a micro-LED array; and
move, by one or more motors coupled to a display platform on which the micro-LED array is situated or a build platform to which a cured resin adheres, the display platform or the build platform.

18. The control circuit of claim 17, wherein moving the display platform or build platform includes moving the display platform or build platform by less than a pitch between directly adjacent LEDs of the micro-LED array, and the method further comprises exposing the resin, via the micro-LED array, before and after the moving of the display platform or build platform.

19. The control circuit of claim 17, wherein the light from the micro-LED array is provided directly to the resin in the resin tank.
